(19) United States
(12) Patent Application Publication
(10) Pub. No.: US 2006/0116972 A1
(43) Pub. Date: Jun. 1, 2006

(54) Integrated parking meter system

(76) Inventor: Yean Yee Wong, Bolingbrook, IL (US)

Correspondence Address: Yean Yee Wong, 374 Deering Lane, Bolingbrook, IL, 60440, US

(21) Appl. No.: 11/000,761

(22) Filed: Dec. 1, 2004

(51) Int. Cl. G07B 15/02

(52) U.S. Cl. 705/418

(57) ABSTRACT

This invention concerns an integrated parking meter system, and a method for controlling the same, capable of preventing inadvertent over-time parking or over-paying parking, which comprises a central control system, a parking meter, and a data communication system. The data communication system connects the parking meter to the central control system, and enables secured data communication between the parking meter and the central control system.

### BACKGROUND OF THE INVENTION

1. Field of the Invention

The present invention relates to an integrated parking meter system. More specifically, my invention is primarily relates to an integrated parking meter system that is capable of preventing inadvertent over-time parking or over-paying parking. The current invention enables the municipalities, who operate current invention, to collect the most parking meter charges possible at the minimum cost, and treat fairly to all the drivers who choose to park their cars at such integrated parking meter system.

2. Description of the Prior Art

Parking meter systems have been widely adopted by almost all the municipalities in collecting parking revenue from drivers, who choose to park their cars at the parking meters. Most of the commonly used parking meters nowadays are the mechanical or electrical operated coin-operated parking meters. The coin-operated parking meters could only accept certain coins with fixed charging rated installed. The coin-operated parking meters could only charge fixed rate throughout the day, and could not identify the time period, when they are in operation. These internal limitations of the coin-operated parking meters bring up some of the major problems to the drivers. If the driver does not have coins with him, he could not use the coin-operated parking meter to park his car. If the driver leaves before the expiration of the meter, he could not get a refund for the over-payment. If the driver does not leave upon the expiration of the meter, he might be fined for over-time parking if parking enforcement personnel acknowledges such over-time parking. Parking at minimum cost and finding most revenue from the parking meter are a constant struggle between the drivers and the municipalities.

Currently municipalities employ many parking meter attendants to randomly search for parking meter violators. When a violator is found, the parking attendant issues a citation and then continue to look for other violators. If none of the drivers are caught with the over-time parking, the municipality would not be able to recoup the costs incurred by the employment of the parking meter attendants. In order to improve the parking meter enforcement, several improvements have been made to the conventional coin-operated parking meter system.

U.S. Pat. No. 4,876,540 issued to Berthon et al. discloses a system for controlling metered parking of road vehicles. The system for controlled meter parking of road vehicles comprises a parking meter and a portable terminal for use by a checker of the controlled meter parking. A keyboard allows drivers to enter vehicle data. A parking time limit is calculated as the function of the amount of money paid. The parking meter then stores pairs of data items, where each pair contains a vehicle data item and an associated parking time limit. In one embodiment, the amount of money is read from a memory card to allow the driver to receive credit for any time not used upon return to pick up the car. The system includes a clock for comparison with the parking time limits. When the comparison with the clock indicates that a parking time limit has expired, the associated pair of data items are deleted from the parking meter memory. A portable terminal allows a checker to enter identification data corresponding to a vehicle actually parked in one of the parking spaces. If there is no identification data in the parking meter memory corresponding to the data entered by the checker, a warning signal goes off on the portable terminal to alert the checker that the vehicle is in violation. Further, if the checker determines that the parking time limit in the portable terminal memory has expired by comparing that limit with a clock in the portable terminal, the warning signal all goes off. This system for controlled meter parking of road vehicles provides some valuable improvements for the parking enforcement personnel to enforce the parking regulations. However, it does not provide an effective and efficient way to minimize the work load of the municipalities in enforcing the parking regulations for the meter parking. It also fails to provide the drivers with any solutions to prevent the unintentional over-time parking.

U.S. Pat. No. 5,029,094 issued to Mr. Wong in 1991 discloses a computerized parking meter system. This computerized parking meter system comprises a host computer and a plurality of parking meters. Each parking meter is provided with a supersonic metal sensor to register parking time, to calculate parking fees and to automatically detect whether a specified parking space is available for a car whereby overtime parking can be accurately recorded. The parking meters are connected to the host computer over power lines. This computerized parking meter system provides some improvements to the conventional coin-operated parking meter system. However, this computerized parking meter system is way too complicated in structure and expensive in manufacturing.

U.S. Pat. No. 6,037,880 issued to Manion in 2000 discloses an integrated parking meter system automates the issuance of parking citations. Each parking meter will be equipped with a sonar range finder, mercury type switch and a two way radio that communicates via N-PCS to a host computer back at the control center. When a meter runs out of money it checks to see if a vehicle is present in the parking space. If it is, the meter notifies the host computer that there is a car illegally parked in the space. The host computer correlates the information to identify the exact location of the violator. The host computer then sends this information via wireless network to the parking meter attendants' personal communicator. The parking attendant proceeds to the violator and issues the citation. Included within this technology is the capability to remotely change the rate structure of any or all electronic parking meters. A meter diagnostic feature alerts repair personnel to specific malfunctioning meters. The meter may also set the time remaining on the meter to zero whenever a car leaves the adjacent space. Again, this improvement only provides the government with a more effective way to detect the violation and issue the ticket. However, this improvement still leaves the drivers with no way to avoid the un-intentional over-time parking.

What is needed then is an integrated parking meter system that can prevent inadvertent over-time parking at the parking meter.

Accordingly, it is a principal objective of my invention to provide an integrated parking meter system that can accept various kinds of payment, especially the credit-card-like means of payment;

It is a further objective of my invention to provide an integrated parking meter system that can be employed to charge different parking rates for different time period of a day;

It is a still further objective of my invention to provide an integrated parking meter system that can be employed to broadcasting the availability of various parking meters to authorized personnel, including both the parking meter attendants and authorized drivers, who are looking for meter parking; and

It is a still further objective of my invention to provide an integrated parking meter system that is capable of sensing the present of the illegal parked car while the parking meter is at vacant status.

Other objects of my invention, as well as particular features, elements, and advantages thereof, will be elucidated in, or apparent from, the following description and the accompanying drawing figures.

### SUMMARY OF THE INVENTION

According to my present invention, I have provided an integrated parking meter system capable of preventing inadvertent over-time parking or over-paying parking.

The present invention provides an integrated parking meter system capable of preventing inadvertent over-time parking or over-paying parking. Said integrated parking meter system comprises a central control system, a secured data communication system, and a parking meter. Said parking meter can be a plurality of parking meters. Said central control system further comprising a parking rate database, a parking status database, and a fee charging database. Said parking meter connects to said central control system through said secured data communication system. Said parking meter further comprises a rate setup system, a parking status system, and a fee charging system.

Said rate setup system is capable of receiving a parking rate from said parking rate database of said central control system through said secured data communication system to enable said parking meter to charge different rate for different period of time. Said parking status system is capable of gathering a parking status, including a valid parking status, an overtime parking status, a vacant parking status and a repair status, and updating said parking status to said central control system through said secured data communication system from time to time. Said fee charging system is capable of gathering payment data from various kinds of payment means, producing evidence to verify said payment data gathered from various kinds of payment means, and transmitting said payment data to said central control system through said secured data communication system to update said fee charging database.

The present invention also provides a method for controlling an integrated parking meter system capable of preventing inadvertent over-time parking or over-paying parking. Said method comprises following steps:
updating a parking meter, said parking meter being a plurality of parking meters, with a current parking fee rate by a central control system through a secured data communication system linking said parking meter to said central control system;
updating said central control system with the presence of a car parking at said parking meter from time to time by said parking meter through said secured data communication system;
receiving a first payment reading data from a first driver by said parking meter;
initiating charging process for parking car at said parking meter;
receiving a second payment reading data from said first driver by said parking meter;
terminating charging process for parking car at said parking meter; and
broadcasting availability of said parking meter to authorized personnel.

### DESCRIPTION OF THE DRAWINGS

Other features of my invention will become more evident from a consideration of the following detailed description of my patent drawings, as follows:

FIG. 1 is a structure demonstration drawing of the preferred embodiment of current invention;

FIG. 2 is a flow chart for the method for controlling the preferred embodiment of current invention.

### DETAILED DESCRIPTION OF THE PREFERRED EMBODIMENT

Referring now to the drawings, my invention concerns an integrated parking meter system capable of preventing inadvertent over-time parking or over-paying parking.

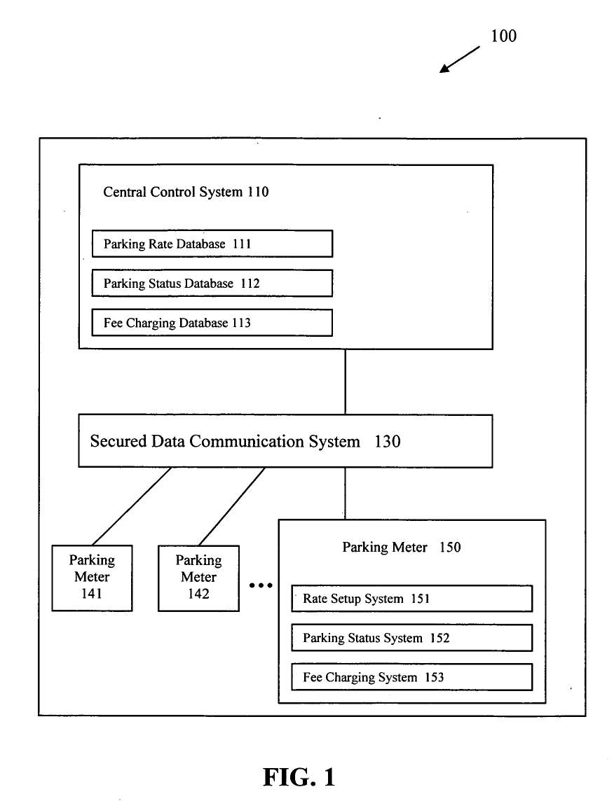

Referring now to FIG. 1, which is a structure demonstration drawing of the preferred embodiment of current invention 100. Said integrated parking meter system 100 comprises a central control system, 110, a secured data communication system 130, and a plurality of parking meters, including parking meter 141, parking meter 142, parking meter 150, etc. All parking meter 141, parking meter 142 and parking meter 150 have identical structure.

Said central control system 110 further comprises a parking rate database 111, a parking status database 112, and a fee charging database 113. The parking rate database 111 has all the available parking rates established by the local municipality ordinance towards applicable to various parking meters at different locations at different time throughout the day. By adopting such a parking rate database 111, said integrated parking meter system 100 is capable of charging different rate at different time throughout the day for each parking meter of such a parking rate database 111, including parking meter 141, parking meter 142 and parking meter 150. The parking status database 112 has all the parking status of each individual parking meters of this integrated parking meter system 110 at anytime, including the parking status of parking meter 141, parking meter 142 and parking meter 150. By adopting such a parking status database 112, said integrated parking meter system 100 is capable of providing the parking status of all the parking meters of said integrated parking meter system 100 at any time, including the parking status of parking meter 141, parking meter 142 and parking meter 150. The integrated parking meter system 100 is capable of broadcasting the parking status information of said parking status database 112 to authorized personnel, including drivers who are looking for a vacant parking meter in their neighborhood and parking meter attendants who are in the process of checking out violation parking. The fee charging database 113 has all the current fee charging status of each parking meter of this integrated parking meter system 100, including the fee charging status of parking meter 141, parking meter 142 and parking meter 150. The fee charging status includes the payment information, starting time of activation of the parking meter, termination time of the parking meter, provided by the drivers for the parking of the cars at the parking meters of this integrated parking meter system 100, including parking meter 141, parking meter 142 and parking meter 150. A driver activates the parking meter 150 to start his parking by entering into the parking meter the payment information, including the information from an authorized charge source, and terminates the parking by inputting again the payment information. The parking meter 150 starts the counting when it receives the first payment input, such as a credit card reading, and terminates the counting when it receives the same payment input again same as the first payment input. By adopting such a fee charging database 113, the integrated parking meter system 100 is capable of calculating the time a driver parking his car at the parking meter 150 by recording the payment information inputting at the starting time and termination time. By adopting such a fee charging database 113, the integrated parking meter system 100 is also capable of eliminating any potential over parking of the car by the driver, because the total charge would be paid by the credit card, debt card, or any other kind of authorized payment card at the conclusion of the parking. If there exists a blackout period during a day that parking at the parking meter 150 is free of charge, the integrated parking meter system 100 is capable of stopping the time counting when the time reaches the blackout period. If a driver parks a car at the parking meter 150 before the finish of the blackout period, the driver can in put the payment information into say parking meter 150. The integrated parking meter system 100 will not start the time counting for the parking, until the blackout time finishes. The feature of this integrated parking meter system 100 provides great convenience to the driver who parks the car at the parking meter 150.

The parking meter 150 connects to said central control system 110 through said secured data communication system 130. Said parking meter further comprises a rate setup system 151, a parking status system 152, and a fee charge system 153. Said rate setup system 151 is capable of receiving a parking rate from said parking rate database 111 of said central control system 100 through said secured data communication system 130 to enable said parking meter 150 to charge different rate for different period of time. This provides a great flexibility and fairness to the charges collected by the parking meter 150. During different period of time, there are different needs for the parking at certain location. As a result, different parking fee charge structure shall be in place. The parking status system 152 is capable of reflecting the current parking status. Said parking status can be a valid parking status, an overtime parking status, a vacant parking status and a repair status, and updating said parking status to said central control system 110 through said secured data communication system 130 from time to time. The parking status system 152 is capable of sensing the presence of a car parked at the parking meter 150, and updating such parking status from time to time to the central control system 110. The central control system 110 is capable of comparing the parking status of the parking meter 150 at the parking status database 112 with the parking status updated by said parking status system 152. If there is an inconsistence, such as the parking status at the parking status database 112 is vacant, and the parking meter 150 sensing the presence of a parked car at the meter, the integrated parking meter system 100 can conclude that the car parking at the parking meter 150 is parking without paying. As a result, the parking meter attendant could be informed and sent to the parking meter 150 to register a parking violation. Said fee charging system 153 is capable of gathering payment data from various kinds of payment means, producing evidence to verify said payment data gathered from various kinds of payment means, and transmitting said payment data to said central control system 110 through said secured data communication system 130 to update said fee charging database 113.

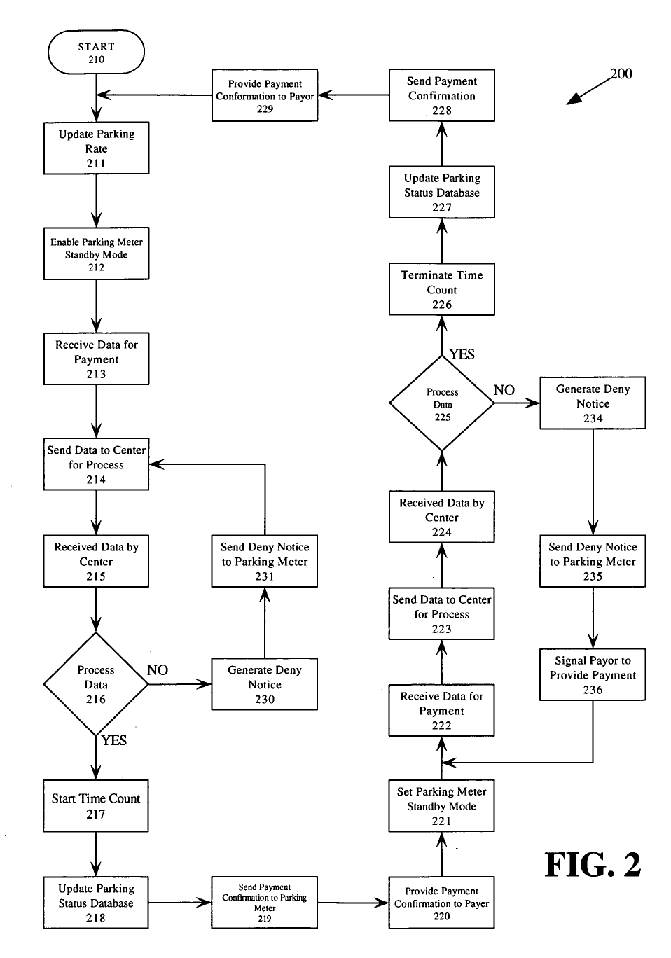

Referring now to FIG. 2, which is a flow chart for the method for controlling the preferred embodiment of current invention. Said process starts out at step 210 and proceeds to step 211. At step 211, the process enables said central control system 110 to update said parking meter 150 with the parking rate from said parking rate database 111 according to the time, and then proceeds to step 212. At step 212, the process enables the parking meter 150 to a standby mode A, and proceeds to step 213. The standby mode A enables the parking meter 150 to receive the payment information from driver who parks the card at the parking meter 150. At the same time, the parking meter 150 is capable of sensing the presence of a parked car at the parking meter 150, if the parking meter 150 is set at standby mode A. This provides the integrated parking meter system 110 the capability to deter any unpaid parking at the parking meter 150. At step 213, the process receives an input of payment data from a driver who parks the car at the parking meter 150, and proceeds to step 214. The parking meter 150 is capable of accepting all kinds of authorized payment method, including credit card, debt card, payment card, even cellular phone. The parking meter 150 can accept the dial in from a cellular phone to register the cellular phone number through the caller id. At step 214, the process send the payment data from the driver by said fee charging system 153 to said central control system 110 through said secured data communication system 130. At step 215, the payment data is received by said central control system 110, and proceeds to step 216. At step 216, the process verifies the payment data received with the information it has. If the payment data is the information from a credit card, the information would be processed to see if this is a valid credit card. If the payment data is the caller id of a cellular phone, the information would be processed to see if this call id is a valid cellular phone called id. If the payment information is valid for charging the parking payment, the process proceeds to step 217. At step 217, the process starts the time counting of said parking meter 150, and proceeds to step 218. At step 218, the process updates the parking status database 112 to list the status of parking meter 150 being at a valid parking status, and proceeds to step 219. At step 219, the process sends the payment confirmation to parking meter 150 by said central control system 110, and proceeds to step 220. At step 220, the process provides the driver who parks the car at parking meter 150 the payment confirmation by said parking meter 150, and proceeds to step 221. At step 221, the process sets the parking meter 150 to standby mode B, and proceeds to step 222. The standby mode B will enable the parking meter ready to accept the payment information from the driver, and at the same time, the parking meter 150 will not up date central control system 110 with the presence of a parked car at said parking meter 150. At step 222, the process receives the payment data again from the driver who parks the car at the parking meter 150, and proceeds to step 223. At step 223, the process sends the payment data received by said parking meter 150 to said central control system 110 through said secured data communication system 130, and proceeds to step 224. At step 224, the payment data received by the central control system 110, and proceeds to step 225. At step 225, the process matches the payment data received while the parking meter 150 being at standby mode B to the payment data received while the parking meter 150 being at standby mode A. If two payment data matches, the process proceeds to step 226. At step 226, the process terminates the time counting on the parking meter 150, and proceeds to step 227. At step 227, the process updates said parking status database 112, set the status of parking meter 150 to vacant, and proceeds to step 228. At step 228, the process send the payment confirmation from central control system 110 to said parking meter 150, and proceeds to step 229. At step 229, the process provides the payment confirmation to the driver, and proceeds back to step 211 to update parking rate from said parking rate database 111 to said parking meter 150.

Returning to step 216. If the payment data received by said central control system 110 is invalid payment data, the proceed proceeds to step 230. At step 230, the process generate a deny notice, and proceeds to step 231. At step 231, the process sends the deny notice by said central control system 110 to said parking meter 150, and proceeds to step 232. At step 232, the process provides the driver with the deny notice and request for input payment information and proceeds back to step 213.

Returning to step 225. If the payment data received by said central control system 110 when the parking meter 150 being at standby mode B does not match the payment data received by said central control system 110 when the parking meter 150 being at standby mode A, the process proceeds to step 234. At step 234, the process generates a deny notice, and proceeds to step 235. At step 235, the process sends the deny notice to parking meter 150 by said central control system 110, and proceeds to step 236. At step 236, the process provides the driver with the deny notice and request the driver to again input payment information by said parking meter 150, and proceeds back to step 222.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

I claim:

1. An integrated parking meter system capable of preventing inadvertent over-time parking or over-paying parking, said integrated parking meter system comprising:
a central control system, said central control system further comprising a parking rate database, a parking status database, and a fee charging database;
a secured data communication system; and
a parking meter, said parking meter being a plurality of parking meters, connecting to said central control system through said secured data communication system, said parking meter further comprising a rate setup system, said rate setup system capable of receiving a parking rate from said parking rate database of said central control system through said secured data communication system to enable said parking meter to charge different rate for different period of time, a parking status system, said parking status system capable of gathering a parking status, said parking status being a valid parking status, an overtime parking status, a vacant parking status and a repair status, and updating said parking status to said central control system through said secured data communication system from time to time, and a fee charging system, said fee charging system capable of gathering payment data from various kinds of payment means, producing evidence to verify said payment data gathered from various kinds of payment means, and transmitting said payment data to said central control system through said secured data communication system to update said fee charging database.

2. The integrated parking meter system of claim 1, wherein said central control system is capable of broadcasting said parking status to authorized personnel.

3. The integrated parking meter system of claim 1, wherein said parking meter can sense the presence of a car parked at said parking meter, and update said central control system about the presence of said car through said secured data communication system.

4. An integrated parking meter system capable of preventing inadvertent over-time parking or over-paying parking, said integrated parking meter system comprising:
a central control system;
a parking meter, said parking meter being a plurality of parking meters;
a data communication system, said data communication system connecting said parking meter to said central control system, and enabling secured data communication between said parking meter and said central control system.

5. The integrated parking meter of claim 4, wherein said central control system further comprises a parking rate database, a parking status database, and a fee charging database.

6. The integrated parking meter of claim 4, wherein said parking meter further comprises a rate setup system, said rate setup system capable of receiving rate information from said central control system through said data communication system, and enabling said parking meter to charge different parking rates for different period of time, a parking status system, said parking status system capable of gathering a parking status, said parking status being a valid parking status, an overtime parking status, a vacant parking status and a repair status, and updating said parking status to said central control system through said data connection system from time to time, and a fee charging system, said fee charging system capable of gathering payment data from various kinds of means of payments, producing evidence to verify said payment data gathered from various kinds of means of payments, and updating said payment data to said central control system through said data communication system.

7. The integrated parking meter system of claim 4, wherein said parking meter can sense the presence of a car parked at said parking meter, and update said central control system about the presence of said car through said data communication system.

8. The integrated parking meter system of claim 4, wherein said central control system is capable of broadcasting said parking status to authorized personnel.

9. An integrated parking meter system capable of preventing inadvertent over-time parking or over-paying parking, said integrated parking meter system comprising:
a central control system;
a parking meter;
a data communication system, said data communication system enabling secured data communication between said parking meter and said central control system.

10. The integrated parking meter of claim 9, wherein said parking meter further comprises a rate setup system, said rate setup system capable of receiving rate information from said central control system through said data communication system, and enabling said parking meter to charge different parking rates for different period of time.

11. The integrated parking meter of claim 10, wherein said parking meter further comprises a parking status system, said parking status system capable of gathering a parking status data, and sending said parking status data to said central control system through said data connection system.

12. The integrated parking meter of claim 11, wherein said parking meter further comprises a fee charging system, said fee charging system capable of gathering a payment data from various kinds of means of payments, producing a verification for said payment data, and transmitting said payment data to said central control system through said data communication system.

13. The integrated parking meter system of claim 12, wherein said parking meter can be a plurality of parking meters, each of which capable of independently communicating to said central control system through said data communication system.

14. The integrated parking meter system of claim 13, wherein said central control system is capable of broadcasting said parking status to authorized personnel.

15. The integrated parking meter system of claim 14, wherein said central control system further comprises a parking rate database, said parking rate database having all parking rates for different time period for said parking meter, a parking status database, said parking status database having all parking status data of said parking meter, and a fee charging database, said fee charging database having said payment data received by said parking meter.

16. A method for controlling an integrated parking meter system capable of preventing inadvertent over-time parking or over-paying parking, said method comprising:
updating said integrated parking meter system with a current parking charge rate, said integrated parking meter system comprising a central control system, said central control system having a parking status database, a secured data communication system, and a parking meter, said parking meter being a plurality of parking meters, connecting to said central control system through said secured data communication system, said parking meter further comprising a rate setup system, said rate setup system capable of receiving and storing all said current parking charge rate to enable said parking meter to charge different rate for different period of time, a parking status system, said parking status system capable of gathering a parking status, said parking status being a valid parking status, an overtime parking status, a vacant parking status, and a repair status, and updating said parking status to said central control system through said secured data communication system, and a fee charging system, said fee charging system capable of gathering payment data from various kinds of means of payments, producing verification for said payment data gathered, and transmitting said payment data to said central control system through said secured data communication system;
setting said parking meter to said vacant parking status;
receiving a first charging data by said fee charging system;
sending said first charging data by said fee charging system to said central control system through said secured data communication system;
receiving said first charging data by said central control system;
validating said first charging data by said central control system;
initiating time count for said parking meter by said central control system;
generating a valid parking status and a fee charging initiation confirmation by said central control system;
updating said parking status database with said valid parking status;
sending said valid parking status by said central control system to said parking status system through said secured data communication system;
sending said fee charging initiation confirmation by said central control system to said fee charging system through said secured data communication system;
updating said parking status system to said valid parking status;
producing said fee charging initiation confirmation by said fee charging system;
receiving a second charging data by said fee charging system;
sending said second charging data by said fee charging system to said central control system through said secured data communication system;
receiving said second charging data by said central control system;
validating said second charging data by said central control system;
terminating time count for said parking meter by said central control system;
generating said vacant parking status and a fee charging termination confirmation by said central control system;
updating said parking status database with said vacant parking status;
sending said vacant parking status by said central control system to said parking status system through said secured data communication system;
sending said fee charging termination confirmation by said central control system to said fee charging system through said secured data communication system;
updating said parking status system to said vacant parking status; and
producing said fee charging termination confirmation by said fee charging system.

17. The method of claim 16, wherein information from said parking status database can be communicated to various authorized personnel to enable said various authorized personnel to locate said parking meter along with said current parking charge rate.

18. An apparatus for controlling an integrated parking meter system capable of preventing inadvertent over-time parking or over-paying parking, said apparatus comprising
means for updating said integrated parking meter system with a current parking charge rate, said integrated parking meter system comprising a central control system, said central control system having a parking status database, a secured data communication system, and a parking meter, said parking meter being a plurality of parking meters, connecting to said central control system through said secured data communication system, said parking meter further comprising a rate setup system, said rate setup system capable of receiving and storing all said current parking charge rate to enable said parking meter to charge different rate for different period of time, a parking status system, said parking status system capable of gathering a parking status, said parking status being a valid parking status, an overtime parking status, a vacant parking status, and a repair status, and updating said parking status to said central control system through said secured data communication system, and a fee charging system, said fee charging system capable of gathering payment data from various kinds of means of payments, producing verification for said payment data gathered, and transmitting said payment data to said central control system through said secured data communication system;
means for setting said parking meter to said vacant parking status;
receiving a first charging data by said fee charging system;
means for sending said first charging data by said fee charging system to said central control system through said secured data communication system;
means for receiving said first charging data by said central control system;
means for validating said first charging data by said central control system;
means for initiating time count for said parking meter by said central control system;
means for generating a valid parking status and a fee charging initiation confirmation by said central control system;
means for updating said parking status database with said valid parking status;
means for sending said valid parking status by said central control system to said parking status system through said secured data communication system;
means for sending said fee charging initiation confirmation by said central control system to said fee charging system through said secured data communication system;
means for updating said parking status system to said valid parking status;
means for producing said fee charging initiation confirmation by said fee charging system;
means for receiving a second charging data by said fee charging system;
means for sending said second charging data by said fee charging system to said central control system through said secured data communication system;
means for receiving said second charging data by said central control system;
means for validating said second charging data by said central control system;
means for terminating time count for said parking meter by said central control system;
means for generating said vacant parking status and a fee charging termination confirmation by said central control system;
means for updating said parking status database with said vacant parking status;
means for sending said vacant parking status by said central control system to said parking status system through said secured data communication system;
means for sending said fee charging termination confirmation by said central control system to said fee charging system through said secured data communication system;
means for updating said parking status system to said vacant parking status; and
means for producing said fee charging termination confirmation by said fee charging system.

19. The apparatus of claim 18, wherein information from said parking status database can be communicated to various authorized personnel to enable said various authorized personnel to locate said parking meter along with said current parking charge rate.

20. A method for controlling an integrated parking meter system capable of preventing inadvertent over-time parking or over-paying parking, said method comprising:
updating a parking meter, said parking meter being a plurality of parking meters, with a current parking fee rate by a central control system through a secured data communication system linking said parking meter to said central control system;
updating said central control system with the presence of a car parking at said parking meter from time to time by said parking meter through said secured data communication system;
receiving a first payment reading data from a first driver by said parking meter;
initiating charging process for parking car at said parking meter;
receiving a second payment reading data from said first driver by said parking meter;
terminating charging process for parking car at said parking meter; and
broadcasting availability of said parking meter to authorized personnel.

21. The method of claim 20, wherein said parking meter is capable of sending said first payment reading data, and said second payment reading data to said central control system for processing through said secured data communication system.

22. An apparatus for controlling an integrated parking meter system capable of preventing inadvertent over-time parking or over-paying parking, said apparatus comprising:
means for updating a parking meter, said parking meter being a plurality of parking meters, with a current parking fee rate by a central control system through a secured data communication system linking said parking meter to said central control system;
means for updating said central control system with the presence of a car parking at said parking meter from time to time by said parking meter through said secured data communication system;
means for receiving a first payment reading data from a first driver by said parking meter;
means for initiating charging process for parking car at said parking meter;
means for receiving a second payment reading data from said first driver by said parking meter;
means for terminating charging process for parking car at said parking meter; and
means for broadcasting availability of said parking meter to authorized personnel.

23. The apparatus of claim 22, wherein said parking meter is capable of sending said first payment reading data, and said second payment reading data to said central control system for processing through said secured data communication system.
